(19) United States
(12) Patent Application Publication
(10) Pub. No.: US 2026/0179966 A1
(43) Pub. Date: Jun. 25, 2026

(54) ELECTRODE AND AN ANODE-FREE ALL-SOLID-STATE BATTERY INCLUDING THE SAME

(71) Applicants: HYUNDAI MOTOR COMPANY, Seoul (KR); KIA CORPORATION, Seoul (KR); IUCF-HYU (Industry-University Cooperation Foundation Hanyang University), Seoul (KR)

(72) Inventors: Ki Yoon Bae, Hwaseong-si (KR); Sang Heon Lee, Hwaseong-si (KR); Jong Chan Song, Hwaseong-si (KR); Sam Ick Son, Hwaseong-si (KR); Ji Young Kim, Hwaseong-si (KR); Da Young Jun, Seoul (KR); Kyu Seok Kim, Seoul (KR); Yun Jung Lee, Seoul (KR)

(73) Assignees: HYUNDAI MOTOR COMPANY, Seoul (KR); KIA CORPORATION, Seoul (KR); IUCF-HYU (Industry-University Cooperation Foundation Hanyang University), Seoul (KR)

(21) Appl. No.: 19/214,977

(22) Filed: May 21, 2025

(30) Foreign Application Priority Data
Dec. 23, 2024 (KR) 10-2024-0194641

(51) Int. Cl. H01M 4/66; H01M 10/052

(52) U.S. Cl. CPC H01M 4/661; H01M 4/666; H01M 4/669; H01M 10/052

(57) ABSTRACT

An electrode includes a current collector, and a coating layer disposed on the current collector. The coating layer includes magnesium particles, and Group 11 metal nanoparticles, and a weight ratio of the magnesium particles to the Group 11 metal nanoparticles is in a range of 9:1 to 99:1. The coating layer includes magnesium particles, and Groups 12 to 15 metal nanoparticles, and a weight ratio of the magnesium particles to the Group 12 to 15 metal nanoparticles is in a range of 2.3:1 to 99:1.

### CROSS-REFERENCE TO RELATED APPLICATION

This application claims the benefit of and priority to Korean Patent Application No. 10-2024-0194641, filed in the Korean Intellectual Property Office on Dec. 23, 2024, the entire contents of which are incorporated herein by reference.

### TECHNICAL FIELD

The present disclosure relates to an electrode, and an anode-free all-solid-state battery including the same.

### BACKGROUND

Recently, anode-free lithium secondary battery systems have received a lot of attention as a next-generation energy storage device that may realize a high energy density and a high theoretical capacity. In such an anode-free lithium secondary battery system, lithium ions present in a cathode move to an anode through an electrolyte, where they are deposited as metallic lithium. During a charging/discharging process, and lithium undergoes deposition (i.e., lithium metal forms on the anode during charging) and stripping (i.e., lithium metal dissolves back into ions and moves to the cathode during discharging), enabling lithium migration. In this process, this anode-free structure, in which no separate anode active material is present in the anode, may simplify a system and is advantageous in increasing an energy density.

However, an anode-free lithium secondary battery system has had many difficulties in practical implementation due to an unstable and non-uniform deposition problem of lithium. When lithium is unevenly deposited in the anode, lithium dendrite may be formed, which may cause deterioration of an interface with the electrolyte and a cell short circuit through penetration into the solid electrolyte. This problem greatly shortens the lifespan of the battery, and becomes a factor that may reduce safety.

To solve this problem, an electrode, to which a magnesium material having high lithium solubility is applied, has been developed. Magnesium may attract attention as a material that may form an alloy with lithium, and may induce stable deposition of lithium ions. In particular, magnesium provides a high stability in an alloy with lithium, thereby suppressing the formation of lithium dendrites and greatly improving an interfacial stability.

However, because a magnesium material essentially has a low lithium diffusion rate, the rate capability of the all-solid-state battery may be lowered. A low diffusion rate makes it difficult for lithium ions to move during charging and discharging, which may reduce the performance of the battery under high current density conditions. This problem may act as a major obstacle to practical use.

The statements in this Background section merely provide background information related to the present disclosure and may not constitute prior art.

### SUMMARY

The present disclosure has been made to solve the above-mentioned problems occurring in the prior art while advantages achieved by the prior art are maintained intact.

An aspect of the present disclosure provides an electrode that includes magnesium particles and metal nanoparticles of different kinds from magnesium to induce a uniform expansion behavior of the electrode, thereby stabilizing deposition and desorption behaviors of lithium and improving lifespan characteristics.

An aspect of the present disclosure also provides an anode-free all-solid-state battery.

The technical problems to be solved by the present disclosure are not limited to the aforementioned problems, and any other technical problems not mentioned herein should be clearly understood from the following description by those having ordinary skilled in the art to which the present disclosure pertains.

According to an aspect of the present disclosure, an electrode includes a current collector, and a coating layer disposed on the current collector. The coating layer includes magnesium particles, and Group 11 metal nanoparticles, and a weight ratio of the magnesium particles to the Group 11 metal nanoparticles is in a range of 9:1 to 99:1.

According to an aspect of the present disclosure, an electrode includes a current collector, and a coating layer disposed on the current collector. The coating layer includes magnesium particles, and Groups 12 to 15 metal nanoparticles, and a weight ratio of the magnesium particles to the Group 12 to 15 metal nanoparticles is in a range of 2.3:1 to 99:1.

The current collector may include at least one of a copper current collector, a stainless steel current collector, an aluminum current collector, a nickel current collector, a titanium current collector, or an aluminum-cadmium composite current collector.

The Group 11 metal nanoparticles may include at least one of silver nanoparticles, copper nanoparticles, or gold nanoparticles.

The Group 12 to Group 15 metal nanoparticles may include at least one of tin nanoparticles, zinc nanoparticles, bismuth nanoparticles, indium nanoparticles, or gallium nanoparticles.

An average particle diameter of the Group 11 metal nanoparticles or the Group 12 to 15 metal nanoparticles may be equal to or greater than 30 nm and equal to or less than 800 nm.

A thickness of the coating layer may be equal to or greater than 4.0 μm and equal to or less than 5.0 μm.

In the coating layer, the Group 11 metal nanoparticles or the Group 12 to 15 metal nanoparticles may be disposed or dispersed between the magnesium particles.

A thickness of the electrode may be equal to or greater than 14.0 μm and equal to or less than 15.0.

A weight ratio of the magnesium particles to the Group 11 metal nanoparticles may be in a range of 9:1 to 95:1

A weight ratio of the magnesium particles to the Group 12 to 15 metal nanoparticles may be in a range of 2.3:1 to 9:1.

According to an aspect of the present disclosure, an anode-free all-solid-state battery includes a cathode, an anode, and a solid electrolyte layer disposed between the cathode and the anode. The cathode includes a cathode active material layer including a cathode active material. The anode is or includes the electrode described above. The solid electrolyte layer is disposed between the cathode active material layer and the anode.

The solid electrolyte may be at least one of a polymer electrolyte, an oxide-based solid electrolyte, or a sulfide-based solid electrolyte.

Lithium may be present while being dispersed among the magnesium particles after at least 100 charge and discharge cycles.

### BRIEF DESCRIPTION OF THE DRAWINGS

The above and other objects, features and advantages of the present disclosure should be more apparent from the following detailed description taken in conjunction with the accompanying drawings:

FIG. 1 illustrates a schematic diagram of an anode-free all-solid-state battery;

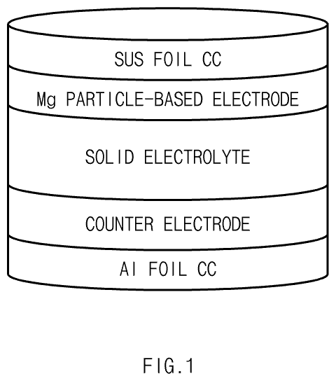

FIG. 2 illustrates a schematic diagram of electrodes of a first embodiment and a first comparative example;

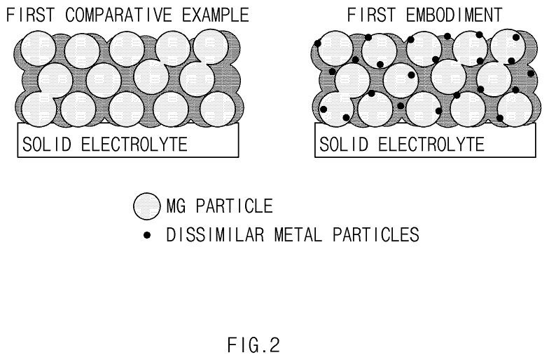

FIG. 3 illustrates an SEM (Scanning Electron Microscopy) image of an electrode after charging and discharging of the first embodiment;

FIG. 4 illustrates an SEM image of an electrode after charging and discharging of a third embodiment;

FIG. 5 illustrates an SEM image of an electrode after charging and discharging of a first comparative example;

FIG. 6 illustrates results of a galvanostatic intermittent titration technique (GITT) analysis of a first embodiment and a first comparative example;

FIG. 7 illustrates results of a galvanostatic intermittent titration technique (GITT) analysis of a third embodiment and a first comparative example;

FIG. 8 illustrates a coulombic efficiency according to the number of charge/discharge cycles of a first embodiment, a third embodiment, a fourth embodiment, a fifth embodiment, a first comparative example, and a second comparative example;

FIG. 9 illustrates an SEM image of an electrode after charging and discharging of a fourth comparative example;

FIG. 10 illustrates a coulombic efficiency according to the number of charge/discharge cycles of a first embodiment, a third comparative example, and a fourth comparative example; and

FIG. 11 illustrates a coulombic efficiency according to the number of charge/discharge cycles of a third embodiment and a fifth comparative example.

The drawings described herein are for illustration purposes only and are not intended to limit the scope of the present disclosure in any way.

### DETAILED DESCRIPTION

Hereinafter, the present disclosure is described in more detail to help understanding of the present disclosure.

Terms or words used in the detailed description of the present disclosure and the claims should not be interpreted as being limited to ordinary or dictionary meanings, and should be interpreted as meanings and concepts that are consistent with the technical idea of this present disclosure. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

### Electrode

The present disclosure includes a current collector, and a coating layer that is located on the current collector, and the coating layer includes magnesium particles; and Group 11 metal nanoparticles, and a weight ratio of the magnesium particles to the Group 11 metal nanoparticles is 9:1 to 99:1.

The present disclosure comprises a current collector, and a coating layer that is located on the current collector, the coating layer includes magnesium particles, and Groups 12 to 15 metal nanoparticles of different kinds from magnesium; and a weight ratio of the magnesium particles to the Group 12 to 15 metal nanoparticles of the different kinds from magnesium is 2.3:1 to 99:1.

According to an embodiment of the present disclosure, the current collector serves as a substrate, by which a coating layer of an electrode may be supported, while providing an electrical conductivity of the electrode of a specific level or more, and has to be a material having a specific level of durability or more.

According to an embodiment of the present disclosure, the current collector may include at least one selected from the group consisting of a copper current collector, a stainless steel current collector, an aluminum current collector, a nickel current collector, a titanium current collector, and an aluminum-cadmium composite current collector. Furthermore, the current collector may have a form, such as a film, a sheet, a foil, a net, a porous material, a foam, a nonwoven fabric, to uniformly form a coating layer on a surface thereof.

According to an embodiment of the present disclosure, a thickness of the current collector may be 10 μm to 20 μm, and more specifically, the thickness of the current collector may be 10.0 μm or more, 10.5 μm or more, 11.0 μm or more, 11.5 μm or more, 12.5 μm or more, 13 μm or more, 13.5 μm or more, 14.0 μm or more, 14.5 μm or more, or 15.0 μm or more, and may be 20.0 μm or less, 19.5 μm or less, 19.0 μm or less, 18.5 μm or less, 18.0 μm or less, 17.5 μm or less, 17.0 μm or less, 16.5 μm or less, 16.0 μm or less, or 15.5 μm or less. When the current collector has the thickness within the above range, an electrical resistance may be reduced and a mechanical stability may be improved, thereby improving an electrochemical performance and a durability of an electrode.

The coating layer is formed on the current collector described above. The coating layer may prevent corrosion of the electrode, improve the conductivity, and protect the electrode from physical and chemical damages by controlling a chemical reaction between the electrode and the electrolyte.

Specifically, the coating layer improves the electrochemical stability of the electrode to avoid or prevent the electrode from corroding or causing unnecessary side reactions with the electrolyte, and to improve the life characteristics of the electrode. Furthermore, the coating layer above may maintain a structural integration of the electrode by mitigating physical damage generated during the charging and discharging process and improving a coupling force between particles. In particular, the coating layer having an ion conductivity provides an ion diffusion path to optimize the uniformity and speed of a reaction, and may promote or control an electrochemical reaction. Furthermore, the coating layer may increase an energy efficiency by reducing an interfacial resistance between an electrode and an electrolyte.

According to one embodiment of the present disclosure, the thickness of the coating layer may be 4.0 μm or more and 5.0 μm or less. More specifically, the thickness of the coating layer may be 4.0 μm or more, 4.1 μm or more, 4.2 μm or more, 4.3 μm or more, 4.4 μm or more, or 4.5 μm or more, and may be 5.0 μm or less, 4.9 μm or less, 4.8 μm or less, 4.7 μm or less, or 4.6 μm or less. When the thickness of the coating layer satisfies the above range, the electrical resistance of the coating layer may be maintained to be lower, thereby further improving the ion conductivity and further improving the mechanical stability of the electrode.

Unlike other metal particles, the magnesium particles induce a unique lithium deposition behavior during battery operation. Specifically, in the case of other metal particles, compared to lithium being deposited in a layered form on the coating layer, the magnesium particles allow lithium to be deposited between the magnesium particles in the coating layer to generate an expansion behavior of the electrode. This expansion behavior maintains a physical contact between the electrode and the solid electrolyte, and may serve to suppress interface deterioration. On the other hand, general layered lithium deposition may cause separation of the solid electrolyte and the electrode interface, thereby causing deterioration of the solid electrolyte. The coating layer containing the magnesium particles may prevent such problems to maintain the stability of the interface, consistently maintain contact between the electrode and the solid electrolyte by suppressing the interface deterioration, and significantly improve the cycle life and stability of the battery. This makes the life characteristics of the electrode very stable, and consequently, a high coulomb efficiency of 99.9% or more may be achieved. The high coulomb efficiency means that there is little loss of charge during the charging and discharging process of the battery, and maximizes the energy efficiency of the battery. Accordingly, the electrode including the coating layer containing the magnesium particles may have a long life such that a full-cell driving is performed for 1,000 cycles or more.

The average particle diameter of the magnesium particles is a particle size at a point of 50% of a cumulative volume distribution according to the particle size of magnesium particles that are present in the coating layer and may be 500 nm or more and 1000 nm or less, and more specifically, the average particle diameter of the magnesium particles may be 500 nm or more, 550 nm or more, 600 nm or more, 650 nm or more, 700 nm or more, or 750 nm or more, and may be 1000 nm or less, 950 nm or less, 900 nm or 850 nm or less, or 800 nm or less. When the average particle diameter of the magnesium particles satisfies the above range, the diffusion path of the lithium ions may be optimized to further improve the rate characteristics of the electrode, and the electrochemical reaction area may be appropriately maintained. Accordingly, when the average particle diameter of the magnesium particles is adjusted within the above range, the uniformity of performance of the electrode may be improved, thereby ensuring a stable performance even in large-scale production. In the specification, the “average particle diameter” means a particle diameter at a point of 50% of the cumulative volume distribution according to the particle diameter. The average particle diameter may be measured by dispersing the powder to be measured in a dispersion medium and introducing it into a commercially available laser diffraction particle size measurement device to calculate a particle size distribution by measuring a diffraction pattern difference according to a particle size when the particles pass through a laser beam, and calculating a particle diameter at a point of 50% of a cumulative volume distribution according to the particle size in the measurement device.

On the other hand, due to the low lithium dynamic properties of the magnesium material, as the current density becomes higher, the lithium deposition behavior becomes more uneven, and low rate capability characteristics and capacity maintenance characteristics may appear. In other words, because the coating layer containing magnesium has a lower ability to maintain a uniform and stable lithium deposition behavior, i.e., an expansion behavior, as the current density becomes higher, the lifespan characteristics becomes worse.

To solve this, the coating layer including the magnesium particles of the present disclosure includes metal nanoparticles of different kinds from magnesium. Specifically, the metal nanoparticles of different kinds from magnesium may increase the movement speed of lithium ions, thereby improving the rate capability characteristics of the electrode and making lithium deposition more uniform even when the current density is high. Furthermore, the metal nanoparticles of different kinds from magnesium may adjust a surface structure of the electrode to enable uniform lithium deposition, and as a result, the capacity maintenance rate and lifespan characteristics of the electrode may be improved, and various metal nanoparticles may provide different electrochemical properties to increase the overall performance of the electrode and secure a long-term stability.

According to an embodiment of the present disclosure, the metal nanoparticles of the different kind from magnesium may be Group 11 metal nanoparticles, or may be Groups 12 to 15 metal nanoparticles of the different kinds from magnesium.

According to an embodiment of the present disclosure, in the case of Group 11 metal nanoparticles that form a solid solution due to a high mutual solubility with lithium, there is a possibility that the effect of improving the lifespan characteristics may be low because there is a concern that the deposition behavior of lithium may be changed as it is dissolved in the deposited lithium. On the other hand, in the case of Groups 12 to 15 metal nanoparticles of the different kinds from magnesium that form an intermetallic compound with lithium, they are not dissolved in the deposited lithium, thereby affecting only the uniform distribution of the initial lithium and not causing additional changes in the deposition behavior. Accordingly, in the case of Group 11 metal nanoparticles, addition of a low content is recommended when the electrode is manufactured, and in the case of Groups 12 to 15 metal nanoparticles of the different kinds from magnesium, a relatively high content is allowed to be added.

According to an embodiment of the present disclosure, the weight ratio of the magnesium particles to the Group 11 metal nanoparticles is 9:1 to 99:1. More specifically, the weight ratio of the magnesium particles to the group 11 metal nanoparticles may be 9 or more:1, 10 or more:1, 11 or more:1, 12 or more:1, 13 or more:1, 14 or more:1, 15 or more:1, 16 or more:1, 17 or more:1, 18 or more:1, 19 or more:1, 20 or more:1, 21 or more:1, 22 or more:1, 23 or more:1, 24 or more:1, 25 or more:1, 26 or more:1, 27 or more:1, 28 or more:1, 29 or more:1, 30 or more:1, 31 or more:1, 32 or more:1, 33 or more:1, 34 or more:1, 35 or more:1, 36 or more:1, 37 or more:1, 38 or more:1, 39 or more:1, 40 or more:1, 41 or more:1, 42 or more:1, 43 or more:1, 44 or more:1, or 45 or more:1, and 99 or less:1, 95 or less: 1, 90 or less:1, 85 or less:1, 80: or less 1, 75 or less:1, 70 or less:1, 65 or less:1, 60 or less:1, 55 or less, or 50 or less: 1. When the weight ratio range of the magnesium particles and the Group 11 metal nanoparticles is satisfied, the expansion behavior and stability of the electrode may be secured. When the weight ratio does not satisfy the above range, a plurality of group 11 metal nanoparticles are dissolved in the deposited lithium, thereby changing the deposition behavior of lithium and not performing a uniform expansion behavior.

According to an embodiment of the present disclosure, the Group 11 metal nanoparticles include at least one selected from the group consisting of silver nanoparticles, copper nanoparticles, and gold nanoparticles.

According to one embodiment of the present disclosure, the weight ratio of the magnesium particles to the Groups 12 to 15 metal nanoparticles of the different kinds from magnesium is from 2.3:1 to 99:1. More specifically, the weight ratio of the magnesium particles and the Groups 12 to 15 metal nanoparticles of the different kinds from magnesium may be 2.3 or more:1, 5.0 or more:1, 7.5 or more:1, 10.0 or more:1, 12.5 or more:1, 15.0 or more:1, 17.5 or more:1, 20.0 or more:1, 22.5 or more:1, 25.0 or more:1, 27.5 or more:1, 30.0 or more:1, 32.5 or more:1, 35.0 or more:1, 37.5 or more:1, 40.0 or more:1, 42.5 or more:1, 45 or more:1, 47.5 or more:1, or 50.0 or more:1, and may be 99.0 or less:1, 97.5 or less:1, 95.0 or less:1, 92.5 or less:1, 90.0 or less:1, 87.5 or less:1, 85.0 or less:1, 82.5 or less:1, 80.0 or less:1, 77.5 or less:1, 75.0 or less:1, 72.5 or less:1, 70.0 or less:1, 67.5 or less:1, 65.0 or less:1, 62.5 or less:1, 60.0 or less:1, 57.5 or less:1, 55.0 or less:1, or 52.5 or less:1. When the weight ratio range of the magnesium particles and the Groups 12 to 15 metal nanoparticles of the different kinds from magnesium above is satisfied, the expansion behavior and stability of the electrode may be secured. When the weight ratio above does not satisfy the above range, a uniform expansion behavior does not occur during deposition of the lithium ions, resulting in unnecessary cracks in the electrode layer, which hinder stable lithium deposition and desorption. Furthermore, when the weight ratio does not satisfy the above range, the conductivity and the electrochemical reaction speed of the electrode decrease, and the storage capacity and the performance of the electrode deteriorate.

According to an embodiment of the present disclosure, the Groups 12 to 15 nanoparticles of the different kinds from magnesium include at least one of tin nanoparticles, zinc nanoparticles, bismuth nanoparticles, indium nanoparticles, or gallium nanoparticles.

According to one embodiment of the present invention, the average particle diameter of the metal nanoparticles of the different kinds from magnesium may be 30 nm or more and 800 nm or less, and more specifically, the average particle diameter of the metal nanoparticles of the different kinds from magnesium may be 30 nm or more, 40 nm or more, 50 nm or more, 60 nm or more, 70 nm or more, 80 nm or more, 90 nm or more, 100 nm or more, 110 nm or more, 120 nm or more, 130 nm or more, 140 nm or more, 150 nm or more, 160 nm or more, 170 nm or more, 180 nm or more, 190 nm or more, 200 nm or more, 210 nm or more, 220 nm or more, 230 nm or more, 240 nm or more, 250 nm or more, 260 nm or more, 270 nm or more, 280 nm or more, 290 nm or more, 300 nm or more, 310 nm or more, 320 nm or more, 330 nm or more, 340 nm or more, 350 nm or more, 360 nm or more, 370 nm or more, 380 nm or more, 390 nm or more, or 400 nm or more, and also 800 nm or less, 790 nm or less, 780 nm or less, 770 nm or less, 760 nm or less, 750 nm or less, 740 nm or less, 730 nm or less, 720 nm or less, 710 nm or less, 700 nm or less, 690 nm or less, 680 nm or less, 670 nm or less, 660 nm or less, 650 nm or less, 640 nm or less, 630 nm or less, 620 nm or less, 610 nm or less, 600 nm or less, 590 nm or less, 580 nm or less, 570 nm or less, It may be 560 nm or less, 550 nm or less, 540 nm or less, 530 nm or less, 520 nm or less, 510 nm or less, 500 nm or less, 490 nm or less, 480 nm or less, 470 nm or less, 460 nm or less, 450 nm or less, 440 nm or less, 430 nm or less, 420 nm or less, or 410 nm or less. When the average particle diameter of the metal nanoparticles of the different kinds from the magnesium satisfies the above range, a balance, such as a capacity, a conductivity, a durability, and the like of the electrode may be optimized. Specifically, as the average particle diameter of the metal nanoparticles of the different kinds from the magnesium becomes smaller, the structural stability of the electrode becomes higher, and the durability and resistance are improved to provide a stable performance for a long time. Furthermore, the metal nanoparticles of the different kinds from magnesium may be more uniformly distributed between the magnesium particles to induce a uniform expansion behavior.

The metal nanoparticles of the different kinds from the magnesium may be present while being disposed between the magnesium particles in the coating layer. Specifically, the metal nanoparticles of the different kinds from the magnesium may be present while being uniformly dispersed between the magnesium particles throughout the coating layer, and such a uniform distribution may increase the overall surface area, thereby improving the reaction speed and efficiency, further improving the conductivity of the electrode, and further increasing the structural stability of the electrode to maintaining the performance even during a long-term use. In particular, the uniform distribution of the metal nanoparticles of different kinds from magnesium may secure the uniformity of the reactivity and the conductivity of the electrode, thereby further improving the stability of the electrode performance.

According to one embodiment of the present disclosure, the thickness of the electrode may be 14.0 μm or more and 15.0 μm or less. More specifically, the thickness of the electrode may be 14.0 μm or more, 14.1 μm or more, 14.2 μm or more, 14.3 μm or more, 14.4 μm or more, or 14.5 μm or less, and may be 15.0 μm or less, 14.9 μm or less, 14.8 μm or less, 14.7 μm or less, or 14.6 μm or less. When the thickness of the electrode satisfies the above range, a sufficient storage capacity and a high energy density of the electrode may be provided to secure a more efficient performance in the energy storage device. Furthermore, when the range of the thickness of the electrode is satisfied, heat may be more uniformly dispersed to prevent overheating and further increase the stability, and a physical durability and a chemical stability may also be improved to further improve the life of the electrode.

In addition to the magnesium particles and the metal nanoparticles of the different kinds from magnesium, a carbon-based conductive material, such as carbon nanotubes and graphene, and a dispersant that helps particles in the coating layer to be uniformly dispersed may be included in the coating layer. In addition, the coating layer may include a stabilizer that provides stability so that nanoparticles do not aggregate or a binder that allows nanoparticles to be attached to each other or to the current collector.

### Method for Manufacturing Electrode

The present disclosure includes: an operation of manufacturing a coating solution by mixing magnesium particles, metal nanoparticles of different kinds from magnesium, a binder, and a solvent (an operation S1); an operation of forming a coating layer on a surface of a current collector by using the coating solution (an operation S2); and an operation of drying the coating layer at a temperature of 100° C. or more and 150° C. or less (an operation S3).

In the operation S1, the binder is a component that aids in coupling of the magnesium particles, the metal nanoparticles of the different kinds from magnesium, and the current collector, and may be added in an amount of about 0.1 wt % to about 10 wt % with respect to the total weight of the coating solution. Examples of such binders may include polyvinylidene fluoride (PVDF), polyvinyl alcohol, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene polymer (EPDM), sulfonated-EPDM, styrene-butadiene rubber, nitrile-butadiene rubber, fluoroelastomer, and various copolymers thereof.

In operation S1, the solvent may be selected from solvents that do not affect the magnesium particles, the metal nanoparticles of the different kinds from magnesium, and the current collector, and specific examples thereof may include dimethyl sulfoxide (DMSO), isopropyl alcohol, N-methylpyrrolidone (NMP), dimethylformamide (DMF), acetone, or water, and one of these alone or a mixture of two or more thereof may be used. The solvent may be used to dissolve or disperse the magnesium particles, the metal nanoparticles of the different kinds from magnesium, and a binder in consideration of the coating thickness and the production yield rate of the coating solution and a viscosity that may exhibit an excellent thickness uniformity when applied for manufacturing the anode is sufficient.

In the operation S2, the Group 11 metal nanoparticles or the Groups 12 to 15 metal nanoparticles of the different kinds from magnesium may be present while being dispersed between the magnesium particles in the coating layer, and the dispersion of the Group 11 metal nanoparticles or the Groups 12 to 15 metal nanoparticles of the different kinds from magnesium may be achieved through physical dispersion, such as a high-speed mixer, an ultrasonic processor, or a vibration stirrer, chemical dispersion using a dispersant, dispersion through a high-temperature and high-pressure process or gas injection, or dispersion through a high-temperature heat treatment or an emulsification method.

In the operation S2, the coating layer may be formed by applying the coating solution onto the current collector and drying it, or by casting the coating solution on a separate support body and then laminating a film obtained through delamination from the support body, on the current collector.

In the operation S3, the coating layer is dried within a specific temperature range, thereby securing the quality and performance of the electrode. Specifically, during drying at a too high temperature, the components in the coating layer may not be uniform or cracks may occur, and during drying at a too low temperature, drying may be incomplete. Furthermore, drying at an appropriate temperature may improve the mechanical properties of the coating layer to increase a resistance to physical damage, thereby maintaining the quality consistency during mass production and stably securing the overall performance of the electrode.

According to one embodiment of the present disclosure, the drying temperature in the operation S3 is 100° C. or more and 150° C. or less. More specifically, the drying temperature in operation S3 above may be 100° C. or more, 101° C. or more, 102° C. or more, 103° C. or more, 104° C. or more, 105° C. or more, 106° C. or more, 107° C. or more, 108° C. or more, 109° C. or more, 110° C. or more, 111° C. or more, 112° C. or more, 113° C. or more, 114° C. or more, 115° C. or more, 116° C. or more, 117° C. or more, 118° C. or more, 119° C. or more, 120° C. or more, 121° C. or more, 122° C. or more, 123° C. or more, 124° C. or more, or 125° C. or more, and may be 150° C. or less, 149° C. or less, 148° C. or less, 147° C. or less, 146° C. or less, 145° C. or less, 144° C. or less, 143° C. or less, 142° C. or less, 141° C. or less, 140° C. or less, 139° C. or less, 138° C. or less, 137° C. or less, 136° C. or less, 135° C. or less, 134° C. or less, 133° C. or less, 132° C. or less, 131° C. or less, 130° C. or less, 129° C. or less, 128° C. or less, 127° C. or less, or 126° C. or less. When the drying temperature satisfies the above range, the coating layer may be uniformly dried to form a structure, in which the magnesium particles and the nanoparticles are stably and uniformly coupled to each other, thereby improving the uniformity of the coating layer and improving the coupling force of the particles.

According to an embodiment of the present disclosure, the operation S3 may be performed for 5 hours or more and 8 hours or less. More specifically, the operation S3 may be performed for 5.0 hours or more, 5.2 hours or more, 5.4 hours or more, 5.6 hours or more, 5.8 hours or more, 6.0 hours or more, 6.2 hours or more, or 6.4 hours or less, and may be performed for 8.0 hours or less, 7.8 hours or less, 7.6 hours or less, 7.4 hours or less, 7.2 hours or less, 7.0 hours or less, 6.8 hours or less, or 6.6 hours or less. When drying of operation S3 is performed for the above time period, the coating layer may improve a drying uniformity, thereby optimizing the physical properties of the coating layer, i.e., a density and a strength, and maintaining a chemical stability. This may improve electrical performance and further increase the mechanical robustness of the coating layer.

### Anode-Free All-Solid-State Battery

The present disclosure provides an anode-free all-solid-state battery that includes a cathode, an anode, and a solid electrolyte layer that is disposed between the cathode and the anode, the cathode includes a cathode active material layer containing a cathode active material, the anode is the electrode, and the solid electrolyte layer is disposed between the cathode active material layer and the anode.

The cathode may include a cathode current collector, and a cathode active material layer that is located on the cathode current collector.

The cathode current collector is not particularly limited as long as it may include a highly conductive metal, and the cathode active material layer is easily adhered, and it is not reactive in the voltage range of the battery. A cathode current collector that is obtained by surface-treating stainless steel, aluminum, nickel, titanium, fired carbon, or a surface of aluminum or stainless steel with carbon, nickel, titanium, silver, or the like may be used. Furthermore, the cathode current collector may generally have a thickness of 3 μm to 500 μm, and the adhesion force of the cathode active material may be increased by forming fine convexo-concaves on the surface of the current collector. For example, it may be used in various forms, such as films, sheets, foils, nets, porous bodies, foams, and nonwoven fabrics.

The cathode active material layer may optionally include a conductive material and a binder as needed, together with the cathode active material. The cathode active material may be one selected from the group consisting of LiCoO₂, LiCoPO₄, LiNiO₂, LiₓNiₐCo_{b}M¹_{c}M²_{d}O₂ (M¹ and M² are each independently one selected from the group consisting of Al, Mn, Cu, Fe, V, Cr, Mo, Ga, B, W, Mo, Nb, Mg, Hf, Ta, La, Ti, Sr, Ba, Ce, F, P, S, and Y, and 0.9≤x≤1.1, 0<a<1.0, 0<b<1.0, 0≤c<0.5, 0≤d<0.5 , a+b+c+d=1.), LiMnO₂, LiMnO₃, LiMn₂O₃, LiMn₂O₄, LiMn₂-eM³eO₂ (M³ is at least one selected from the group consisting of Co, Ni, Fe, Cr, Zn, and Ta, and 0.01≤e≤0.1.), Li₂Mn₃M⁴O₈ (M⁴ is at least one selected from the group consisting of Ci, Ni, Fe, Cu, and Zn.), LiFePO₄, Li₂CuO₂, LiV₃O₈, V₂O₅, Cu₂V₂O₇, and a lithium metal.

The binder of the cathode active material layer serves to improve an attachment between cathode active material particles and an adhesion force of the cathode active material and the current collector. Specific examples include polyvinylidene fluoride (PVDF), polyvinylidene fluoride-hexafluoropropylene copolymer (PVDF-co-HFP), polyvinylalcohol, polyacrylonitrile, polymethyl methacrylate, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene polymer (EPDM), sulfonated-EPDM, styrene butadiene rubber (SBR), fluoroelastomer, polyacrylic acid, and polymers, in which hydrogens thereof are substituted with Li, Na, or Ca, or various copolymers thereof, and one of them alone or a mixture of two or more thereof may be used. The binder may be included in an amount of 0.1 wt % to 15 wt % with respect to the total weight of the cathode active material layer.

The conductive material of the cathode active material layer is used to impart a conductivity to the electrode, and in the configured battery, any material having an electronic conductivity without causing a chemical change may be used without particular limitation. Specific examples include graphite, such as natural graphite or artificial graphite, carbon-based materials, such as carbon black, acetylene black, Ketjen black, channel black, furnace black, lamp black, thermal black, and carbon fiber, metal powders or metal fibers, such as copper, nickel, aluminum, and silver, conductive tubes, such as carbon nanotubes, conductive whiskers, such as zinc oxide or potassium titanate, conductive metal oxides, such as titanium oxide, or conductive polymers, such as polyphenylene derivatives, and the like, and one of them alone or two or more thereof may be used. The conductive material may be included in an amount of 0.1 wt % to 15 wt % with respect to the total weight of the cathode active material layer.

The cathode may be manufactured through a general cathode manufacturing method. Specifically, the cathode may be manufactured by applying the cathode active material and the composition for forming the cathode active material layer that is manufactured by selectively dissolving or dispersing the binder, the conductive material, and the dispersant in the solvent if necessary onto the cathode current collector, and drying and rolling it, and may be manufactured by casting the composition for forming the cathode active material layer on a separate support body and then laminating a film obtained through delamination from the support body on the cathode current collector.

The solvent may be a solvent generally used in the relevant technical field, and may include dimethyl sulfoxide (DMSO), isopropyl alcohol, N-methylpyrrolidone (NMP), dimethylformamide (DMF), acetone, or water, and one of these alone, or a mixture of two or more thereof may be used. The amount of the solvent used is sufficient as long as it dissolves or disperses the cathode active material, the conductive material, the binder, and the dispersant, in consideration of the coating thickness and the production yield rate of the slurry, and has a viscosity that may exhibit an excellent thickness uniformity during subsequent coating for manufacturing the cathode.

The solid electrolyte layer may include at least one selected from the group consisting of a polymer electrolyte, an oxide-based solid electrolyte, and a sulfide-based solid electrolyte, and may include a sulfide-based solid electrolyte.

The anode-free all-solid-state battery may exhibit a sufficient expansion behavior when charging and discharging are performed 100 or more times, and thus lithium may be dispersed and distributed between magnesium particles. Specifically, lithium may not be unevenly deposited in one position as a lump, but may be uniformly dispersed and distributed between the magnesium particles in a specific size.

The exterior of the anode-free all-solid-state battery of the present disclosure is not particularly limited, but may have a cylindrical shape, using a can, a prismatic shape, a pouch shape, or a coin shape.

The anode-free all-solid-state battery according to the present disclosure may be used in a battery cell used as a power source of a small device and may be used as a unit cell in a middle or large-sized battery module including a plurality of battery cells.

Accordingly, a battery module including the anode-free all-solid-state battery as a unit cell and a battery pack including the same are provided.

The battery module or the battery pack may be used as a medium or large-sized device power source at least one of a power tool, an electric vehicle including an electric vehicle (EV), a hybrid electric vehicle, a plug-in hybrid electric vehicle (PHEV), or a power storage system.

Hereinafter, embodiments of the present disclosure are described in detail so that a person having an ordinary skill in the art, to which the present disclosure pertains, may easily practice the present disclosure. However, the present disclosure may be implemented in various different forms and is not limited to embodiments described herein.

### Manufacturing of Electrode

### First Embodiment (Mg:Sn=9:1)

0.045 g of magnesium (Mg) powder, 0.005 g of tin (Sn) powder, 0.001282 g of polyvinylidene fluoride (PVDF), and 0.0083 mL of N-methyl-2-pyrrolidone (NMP) were put into a ball mill container, and zirconia balls with a size of 10 mm were placed and treated at a rotational speed of 35 RPM (revolutions per minutes) for 15 minutes at room temperature to manufacture a coating solution. The manufactured coating solution was applied onto a stainless steel current collector of a size of 6 cm×10 cm by using a 70 μm-gap blade and was dried at 120° C. for 360 minutes to manufacture an electrode.

### Second Embodiment (Mg:Sn=7:3)

An electrode was manufactured in the same manner as in the first embodiment, except that 0.035 g of magnesium (Mg) powder and 0.015 g of tin (Sn) powder were added.

### Third Embodiment (Mg:Ag=9:1)

An electrode was manufactured in the same manner as in the first embodiment, except that instead of tin (Sn) powder, 0.005 g of silver (Ag) powder was added.

### Fourth Embodiment (Mg:Zn=9:1)

An electrode was manufactured in the same manner as in the first embodiment, except that instead of tin (Sn) powder, 0.005 g of zinc (Zn) powder was added.

### Fifth Embodiment (Mg:Bi=9:1)

An electrode was manufactured in the same manner as in the first embodiment, except that instead of tin (Sn) powder, 0.005 g of bismuth (Bi) powder was added.

### First Comparative Example

An electrode was manufactured in the same manner as in the first embodiment, except that tin (Sn) was not added.

### Second Comparative Example (Mg:Al=9:1)

An electrode was manufactured in the same manner as in the first embodiment, except that instead of tin (Sn) powder, 0.005 g of aluminum (Al) powder was added.

### Third Comparative Example (Mg:Sn=5:5)

An electrode was manufactured in the same manner as in the first embodiment, except that 0.025 g of magnesium (Mg) powder and 0.025 g of tin (Sn) powder were added.

### Fourth Comparative Example (Mg:Sn=1:9)

An electrode was manufactured in the same manner as in the first embodiment, except that 0.005 g of magnesium (Mg) powder and 0.045 g of tin (Sn) powder were added.

### Fifth Comparative Example (Mg:Ag=7:3)

An electrode was manufactured in the same manner as in the third embodiment, except that 0.035 g of magnesium (Mg) powder and 0.015 g of silver (Ag) powder were added.

### Manufacturing of Half Cells of Anode-Free All-Solid-State Battery

90 mg of Li₆PS₅Cl_{0.5}Br_{0.5} was put into a mold with an inner diameter of 10 mm and compressed at 200 MPa to manufacture a solid electrolyte layer, and the electrodes manufactured in embodiments and the comparative examples were used as an anode, and the manufactured solid electrolyte layer and the anode were pressed together at 380 MPa such that the anode and the solid electrolyte layer contact each other. Finally, a lithium metal having a thickness of 400 μm was brought into contact with an opposite side to the anode with respect to the solid electrolyte layer as the opposite electrode and then pressed at 5 MPa to manufacture half cells of the anode-free all-solid-state battery.

### First Experimental Example: Identification of Expansion Behavior of Electrode

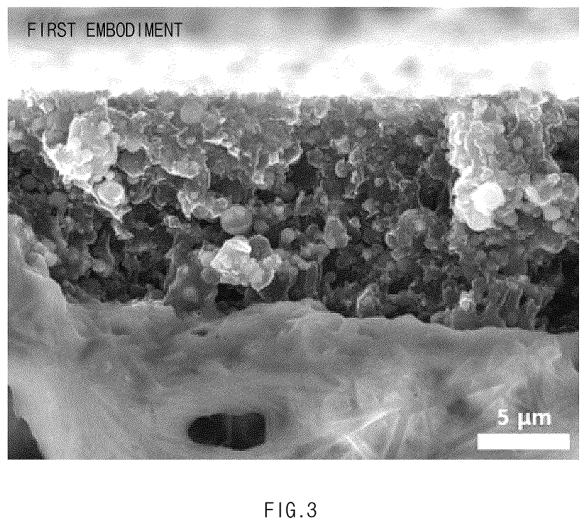

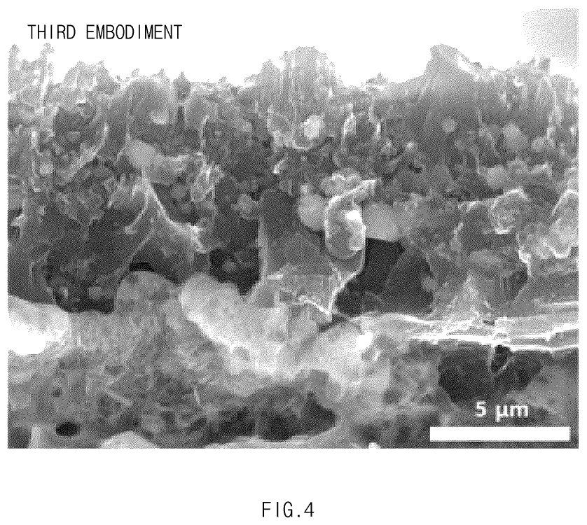

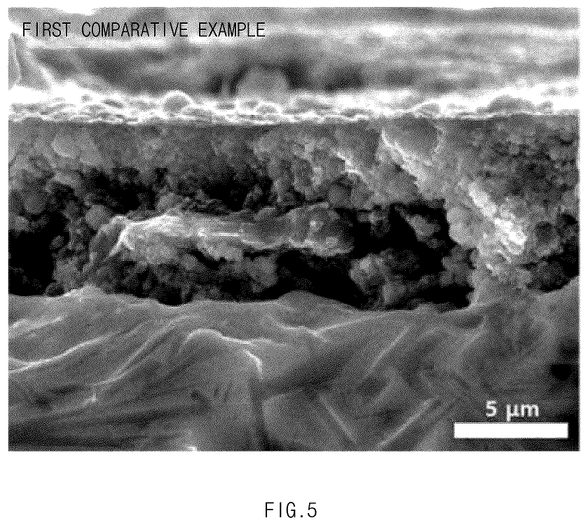

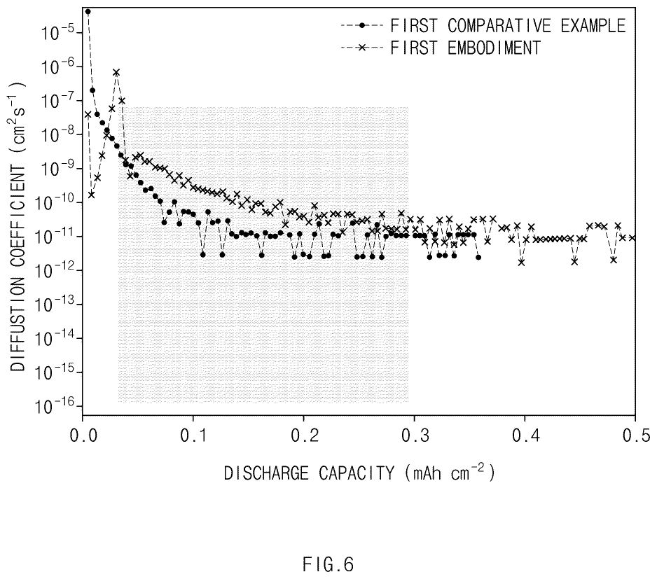

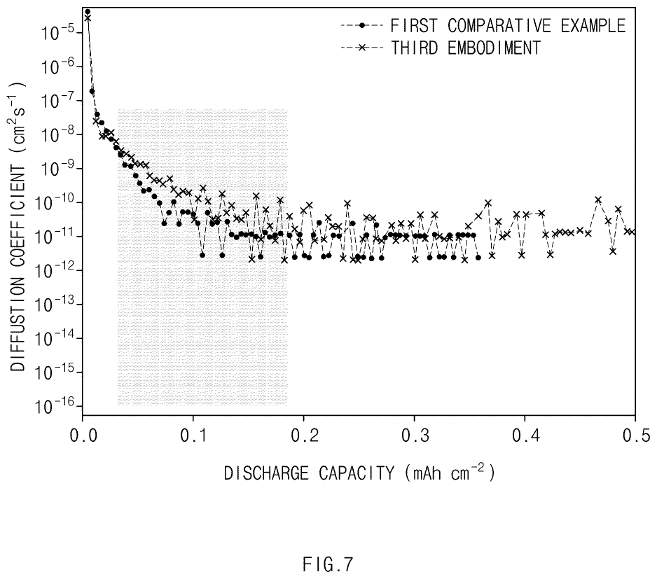

The half cells of the anode-free all-solid-state batteries including the electrodes of the first embodiment, the third embodiment, and the first comparative example were discharged for 4 hours under the condition of a current density of 0.5 mA/cm² and a capacity of 2 mAh/cm² and charged and discharged under the condition of a charge termination voltage of 1 V, a current of 0.25 C, a current density of 0.5 mA/cm², and a capacity of 2 mAh/cm², and the cross sections of the electrodes were observed through a scanning electron microscope (SEM) and the images are illustrated in FIGS. 3-5, and the galvanostatic intermittent titration technique (GITT) analysis results are illustrated in FIGS. 6 and 7.

Referring to FIGS. 3-5, it was identified that the uniformity of lithium deposition in the electrode is increased compared to the electrode manufactured in the first comparative example by using Group 11 metal nanoparticles or the Groups 12 to 15 metal nanoparticles of the different kinds from magnesium as an additive. It appears that the Group 11 metal nanoparticles or the Groups 12 to 15 metal nanoparticles of the different kinds from magnesium induce a uniform expansion of the coating layer in the electrode, thereby increasing a stability of a lithium deposition and desorption behavior and improving long-term lifespan characteristics.

Referring to FIGS. 6 and 7, it may be identified that the electrodes manufactured in the first and third embodiments had a higher lithium diffusion coefficient in the beginning of deposition, in which lithium started to be formed, compared to the electrode manufactured in the first comparative example. It is expected that the fast lithium diffusion rate in the beginning of the lithium deposition process increases an area, in which lithium in the electrode aggregates, and it appears that a uniform distribution of lithium deposition in the electrode is induced in the continued lithium deposition process.

### Second Experimental Example: Evaluation of Lifespan Characteristics of Kind of Metal Nanoparticles of Different Kinds From Magnesium

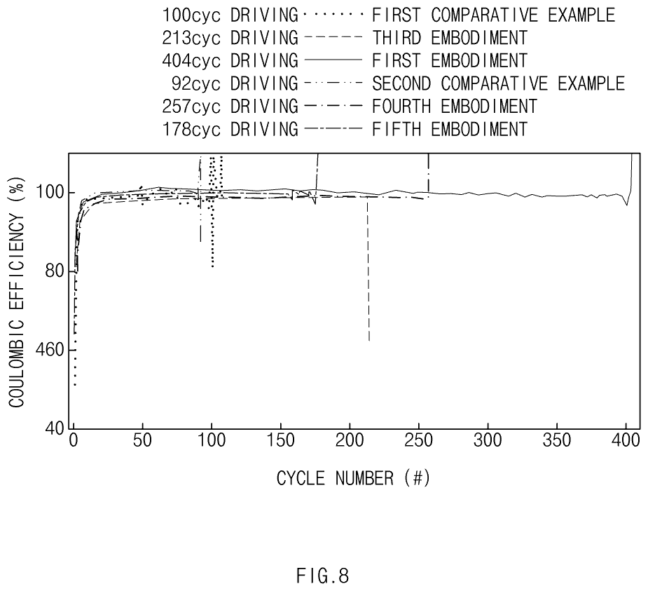

For half cells of the anode-free all-solid-state batteries including the electrodes of the first, third, fourth, and fifth embodiments and the first and second comparative examples, respectively, when discharging was performed for 4 hours under the conditions of a current density of 0.5 mA/cm² and a capacity of 2 mAh/cm², and then charging and discharging were performed under the conditions of an end-of-charge voltage of 1 V, a current of 0.25 C, a current density of 0.5 mA/cm², and a capacity of 2 mAh/cm², the coulombic efficiency according to the number of charging/discharging cycles of the battery was measured, and the results are illustrated in FIG. 8.

Referring to FIG. 8, except for the electrode (the second comparative example) including aluminum (Al), the electrodes (the first, third, fourth, and fifth embodiments) including tin (Sn), silver (Ag), zinc (Zn), and bismuth (Bi) as an additive exhibited improved lifespan characteristic result compared to the electrode (the first comparative example) including only magnesium. Accordingly, it was identified that aluminum (Al) that is a material that cannot smoothly form an alloy phase with lithium was difficult to use as an additive.

### Third Experimental Example: Evaluation of Lifespan Characteristics by Weight Ratio of Particles

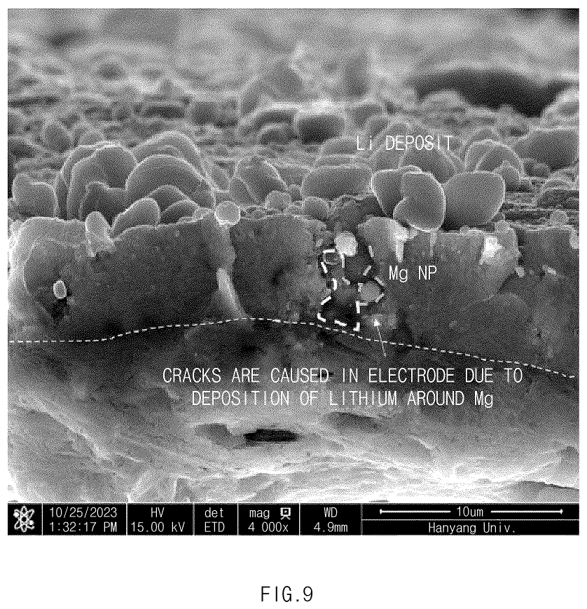

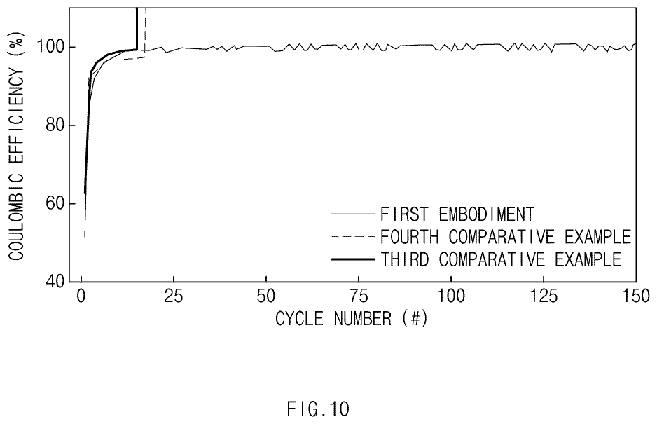

The half cells of the anode-free all-solid-state batteries including the electrodes of the first embodiment and the third and fourth comparative examples were discharged for 4 hours under the condition of a current density of 0.5 mA/cm² and a capacity of 2 mAh/cm² and charged and discharged under the condition of a charge termination voltage of 1 V, a current of 0.25 C, a current density of 0.5 mA/cm², and a capacity of 2 mAh/cm², and the cross sections of the electrodes were observed through a scanning electron microscope (SEM) and the images are illustrated in FIG. 9, and the coulombic efficiencies according to the numbers of charging and discharging cycles of the electrodes were illustrated in FIG. 10.

Referring to FIG. 9, it may be identified that, unlike the electrode manufactured in the first embodiment, in the electrode manufactured in the fourth comparative example, an expansion behavior did not appear, and a lithium deposition was formed around the magnesium particles that are present in the interior of the tin nanoparticle layer. As a result, cracks were caused in the electrode layer, and lithium was not stably deposited or desorbed as in the first embodiment.

Referring to FIG. 10, it may be identified that the electrode manufactured in the first embodiment had a higher coulombic efficiency than the electrode manufactured in the third and fourth comparative examples.

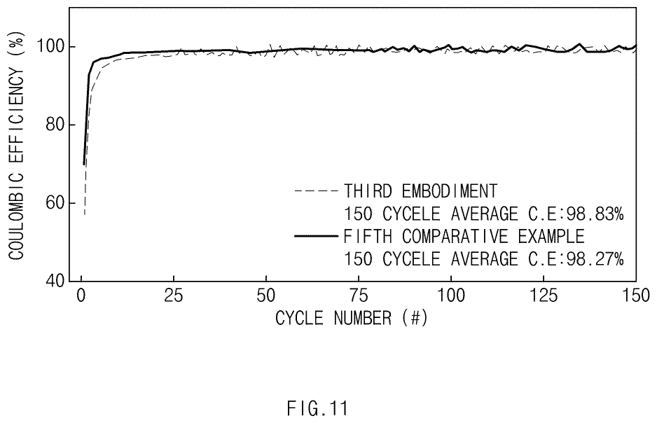

For half cells of the anode-free all-solid-state batteries including the electrodes of the third embodiment and the fifth comparative example, respectively, when discharging was performed for 4 hours under the conditions of a current density of 0.5 mA/cm² and a capacity of 2 mAh/cm², and then charging and discharging were performed under the conditions of an end-of-charge voltage of 1 V, a current of 0.25 C, a current density of 0.5 mA/cm², and a capacity of 2 mAh/cm², the coulombic efficiency according to the number of charging/discharging cycles of the battery was measured, and the results are illustrated in FIG. 11.

Referring to FIG. 11, it may be identified that the electrode manufactured in the third embodiment had excellent lifespan characteristics compared to the manufactured in the fifth comparative example.

The electrode of the present disclosure includes magnesium particles, and metal nanoparticles of different kinds from magnesium by controlling a weight ratio thereof, a low lithium diffusion rate of magnesium may be supplemented, and movement of lithium ions in the electrode may be expedited to improve rate capability characteristics, and uniform expansion behaviors may be induced to secure the stability of lithium deposition and desorption behaviors.

In addition, because the anode-free all-solid-state battery of the present disclosure includes the electrode according to the present disclosure, lifespan characteristics may be improved.

The present disclosure has been described with reference to the example embodiments and the drawings, but the present disclosure is not limited thereby. The present disclosure may be carried out in various forms by those having ordinary skill in the art, to which the present disclosure pertains, within the technical spirit of the present disclosure and the scope of equivalents to the appended claims.

What is claimed is:

1. An electrode comprising:
a current collector; and
a coating layer disposed on the current collector,
wherein the coating layer includes magnesium particles, and Group 11 metal nanoparticles, and
wherein a weight ratio of the magnesium particles to the Group 11 metal nanoparticles is in a range of 9:1 to 99:1.

2. The electrode of claim 1, wherein the current collector includes at least one of a copper current collector, a stainless steel current collector, an aluminum current collector, a nickel current collector, a titanium current collector, or an aluminum-cadmium composite current collector.

3. The electrode of claim 1, wherein the Group 11 metal nanoparticles include at least one of silver nanoparticles, copper nanoparticles, or gold nanoparticles.

4. The electrode of claim 1, wherein an average particle diameter of the Group 11 metal nanoparticles is equal to or greater than 30 nm and equal to or less than 800 nm.

5. The electrode of claim 1, wherein a thickness of the coating layer is equal to or greater than 4.0 μm and equal to or less than 5.0 μm.

6. The electrode of claim 1, wherein in the coating layer, the Group 11 metal nanoparticles are disposed between the magnesium particles.

7. The electrode of claim 1, wherein a thickness of the electrode is equal to or greater than 14.0 μm and equal to or less than 15.0 μm.

8. The electrode of claim 1, wherein the weight ratio of the magnesium particles to the Group 11 metal nanoparticles is in a range of 9:1 to 95:1.

9. An electrode comprising:
a current collector; and
a coating layer disposed on the current collector,
wherein the coating layer includes magnesium particles, and Groups 12 to 15 metal nanoparticles, and
wherein a weight ratio of the magnesium particles to the Group 12 to 15 metal nanoparticles is in a range of 2.3:1 to 99:1.

10. The electrode of claim 9, wherein the Groups 12 to 15 metal nanoparticles include at least one of tin nanoparticles, zinc nanoparticles, bismuth nanoparticles, indium nanoparticles, or gallium nanoparticles.

11. The electrode of claim 9, wherein the weight ratio of the magnesium particles to the Group 12 to 15 metal nanoparticles is in a range of 2.3 to 9:1.

12. The electrode of claim 9, wherein the current collector includes at least one of a copper current collector, a stainless steel current collector, an aluminum current collector, a nickel current collector, a titanium current collector, or an aluminum-cadmium composite current collector.

13. The electrode of claim 9, wherein an average particle diameter of the Group 12 to 15 metal nanoparticles is equal to or greater than 30 nm and equal to or less than 800 nm.

14. The electrode of claim 9, wherein a thickness of the coating layer is equal to or greater than 4.0 μm and equal to or less than 5.0 μm.

15. The electrode of claim 9, wherein in the coating layer, the Group 12 to 15 metal nanoparticles are disposed between the magnesium particles.

16. The electrode of claim 9, wherein a thickness of the electrode is equal to or greater than 14.0 μm and equal to or less than 15.0 μm.

17. An anode-free all-solid-state battery comprising:
a cathode;
an anode; and
a solid electrolyte layer disposed between the cathode and the anode,
wherein the cathode includes a cathode active material layer including a cathode active material, and
wherein the anode includes the electrode, and
wherein the electrode includes
a current collector, and
a coating layer disposed on the current collector,
wherein the coating layer includes magnesium particles, and Group 11 metal nanoparticles, and
wherein a weight ratio of the magnesium particles to the Group 11 metal nanoparticles is in a range of 9:1 to 99:1.

18. The anode-free all-solid-state battery of claim 17, wherein the solid electrolyte layer includes at least one of a polymer electrolyte, an oxide-based solid electrolyte, or a sulfide-based solid electrolyte.

19. The anode-free all-solid-state battery of claim 17, wherein lithium is dispersed among the magnesium particles after at least 100 charge and discharge cycles.
